(19) United States
(12) Patent Application Publication
(10) Pub. No.: US 2004/0246252 A1
(43) Pub. Date: Dec. 9, 2004

(54) Method and apparatus for visualizing data

(76) Inventors: Jesse James Morrow, Irvine, CA (US); Andrew Atilla Pal, Rancho Santa Margarita, CA (US); Mikhail Matveev, Irvine, CA (US); Mark Oscar Worthington, Irvine, CA (US); Michael Craig Browne, Lake Forest, CA (US)

Correspondence Address: Donald Bollella, Esq., BURSTEIN TECHNOLOGIES, Inc., 163 Technology Drive, Irvine, CA, 92618, US

(21) Appl. No.: 10/341,326

(22) Filed: Jan. 13, 2003

Related U.S. Application Data
(60) Provisional application No. 60/348,767, filed on Jan. 14, 2002.

(51) Int. Cl. G06T 11/20

(52) U.S. Cl. 345/440

(57) ABSTRACT

The present invention is a system and method for displaying data captured via analog hardware means. Embodiments of the present invention are directed at visualizing data for the purpose of hardware development, hardware testing, and data analysis. In one embodiment, data analysis is directed at analyzing data received from bio-discs containing biological samples. Another embodiment is a development kit suitable for analyzing the responses received from an A/D card or equivalent hardware. The present invention offers a user interface for interacting with data displayed in linear, two-dimensional, three-dimensional and animated fashions. User can select data range, change display options, save the data, and view data with the help of various levels of zooming and scrolling. Various interpolation techniques are used to generate visually appealing data display when over zooming occurs. Other data alignment techniques are used to correct for potential distortion that arises from collecting sampled data from a bio-disc.

### CROSS-REFERENCE TO RELATED APPLICATIONS

This application claims the benefit of priority from U.S. Provisional Patent Application Ser. No. 60/348,767 filed Jan. 14, 2002, the disclosure of which is hereby incorporated by reference.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The present invention relates to the field of data display, and in particular to a methods and apparatus for displaying digital data sampled from an analog hardware input.

2. Discussion of the Related Art Hardware analog signals are often sampled into digital data for processing. Analog-to-digital (A/D) cards are common devices used to perform such a task. During development of software that uses such data, it is often desirable to see the signal data in a visually appealing manner. However, display tools such as graphs, plots, and charts, for example, are often lacking in software that is bundled with A/D cards. This makes the task of testing and developing A/D cards and accompanying software difficult.

One application of A/D conversion involves biological analysis using bio-discs. A bio-disc is similar to a CD or DVD disc; however, instead of storing audio/visual or other data, a bio-disc may be used to diagnose certain ailments inside or outside of a doctor's office. Bio-discs may be utilized in home medical testing ranging from pregnancy tests to testing for cancer or the Ebola virus. Typically, a test sample (e.g., urine or blood) is placed in a receptacle of the bio-disc and is tested by various means. For example, the fluid may be forced past reactive regions in the disc. Then, the fluid or the regions can be analyzed to determine the test results.

To analyze the fluid or regions, a laser is directed towards the desired location. As the laser light hits the desired location, some or all of the light is absorbed, reflected, or passes through. Some bio-disc readers measure the amount of light reflected and others measure the amount of light that passes through the bio-disc. This measurement produces a continuous signal that is sampled at a sample rate (i.e., the number of times the measured signal is sampled during a time period). The sampled signal in the AND card needs to be displayed in a clear manner to aid analysis of the biological samples deposited on the bio-discs.

Other applications involving the detection of an analog signal source and conversion of such a signal to digital data would also benefit from having a tool that can visualize such data for the purpose for analysis.

### SUMMARY OF THE INVENTION

The present invention is a system and method for displaying data captured via analog hardware means. Various embodiments of the present invention are directed at visualizing data for the purpose of hardware development, hardware testing, and data analysis.

One embodiment of the present invention is a development kit suitable for analyzing the responses received from an A/D (analog-to-digital) card or equivalent hardware apparatus that generates such signal. In one embodiment of the present invention, data captured from an A/D card can be displayed in several fashions to enable testing and analysis. Data can be displayed in a linear, a two-dimensional, or three-dimensional display. For example, in one embodiment, the intensity of the voltage received is plotted on the Z-axis against the sample area of the bio-disc mapped to the X-axis and the Y-axis. In another embodiment, the received data over time is displayed in an animation, which shows a progression of the snapshots of the data display over time. The animation can be displayed in real-time, corresponding to the real-time data received in the hardware apparatus. Animation is particular useful in the area of bio-disc analysis, where changes (e.g. growth and decay) of biological samples can be observed over time.

The visualized data aids the testing and development of A/D cards and accompanying software. Users employing the development kit embodiment of the present invention can visualize data results from trial runs during development. The development kit can also be used for debugging and diagnostic tasks for both the software and hardware related to A/D cards.

The present invention is also more broadly directed at streamlining the process of converting a stream of digital data from an A/D card into a visually clear and appealing display. One embodiment of the development kit includes an A/D card apparatus, controlling driver, and visualization software. Because the required input to the kit is a standardized output from analog-based hardware, a wide range of application can take advantage of the development kit for the display for data captured via such means. For example, the development kit can be used to visualize signals received from sonar sea-floor exploration apparatus, high-power telescopes, speech recognition sensory devices, and a wide variety of other applications.

Other embodiments of the present invention are directed to a method and apparatus for displaying data from an optical bio-disc. The data visualization process corrects for potential skewing due longer outer tracks of the bio-disc. As the bio-disc is read radially outward and data is received along the track, data from a sample area covering multiple tracks must be aligned properly to aid analysis. In one embodiment of the present invention, the data display is left-justified. In another embodiment, the data is centered as it is displayed. In another embodiment, the data is right justified. In yet another embodiment, micro-alignment, a process in which tracks of data are repeatedly repositioned until a suitable alignment is found, is used in displaying the data.

In another embodiment, the present invention is directed toward further alignment of tracks of data received from an optical bio-disc. Display lines representing tracks of data are clipped and/or padded to make all lines of uniform length. In one embodiment, a user specifies that all lines should be displayed as being the same length as the longest line. Shorter lines are padded with a pad value (e.g., 0, 1 or another predetermined number) to make them the same length as the longest line. In one embodiment, the padding is done after the lines are aligned. Thus, if center or micro alignment is used, pad values will be added to both the beginning and end of short data lines. Similarly, if right or left justification is used, pad values will be added to the beginning or end, respectively, of shorter lines.

In another embodiment, a user specifies that all lines should be displayed as being the same length as the shortest line. Longer lines are clipped to make them the same length as the shortest line. In one embodiment, the clipping is done after the lines are aligned. Thus, if center or micro alignment is used, data values will be clipped from both the beginning and end of long data lines. Similarly, if right or left justification is used, the beginning or end, respectively, of longer lines will be clipped.

In yet another embodiment, a user specifies that all lines should be displayed as being some desired length. Longer lines are cut and shorter lines are padded with a pad value (e.g., 0, 1, or another predetermined number) to make them the desired length. In one embodiment, the padding and/or clipping is done after the lines are aligned.

To further enable analysis of data, the present invention can sum, subtract, or otherwise mathematically manipulate data from multiple channels of analog data received. For example, data from two channels can be summed or subtracted to create a resultant data display. Another example is the display of one channel of data super-imposed on data from another channel. Furthermore, display of each data item is not limited to a thresholding system with only two visual representations (e.g., black or white). In one embodiment, a range of visual representations is associated with the range of data values. In one embodiment, the range of representations is in gray scale. In another embodiment, the range of representations is in colors. In one embodiment, the user determines the range of representations and how data values are mapped into the range.

The present invention offers a user interface for interacting with the afore-mentioned data display. For example, the user can select a desired data range, change display options, change color mapping options, save the data, and view data with the help of various levels of zooming and scrolling. Various interpolation techniques such as step interpolation, linear interpolation, and quadratic interpolation are used to generate visually appealing data display when over-zooming occurs.

In one embodiment of the present invention, a data file can be saved as a raw file. Furthermore, a data file can be exported as an image file (e.g. Tiff, BMP, etc) or a CSV (Comma Separated Values) file. In one embodiment, data can further be saved as a Minimum Sample File (MSF).

It is important to note that the present invention presents various embodiments for the purpose data visualization. The original data itself is not modified and can still be exported to other systems for further analysis or storage. Furthermore, the present invention differs from an image processing tool in the sense that it does not manipulate actual digital image data. It represents analog data in various visual schemes to aid data analysis and hardware sensitivity detection.

Embodiments of the present invention are directed to bio-discs, bio-drives, and related methods. This invention or different aspects thereof may be readily implemented in, adapted to, or employed in combination with the discs, assays, and systems disclosed in the following commonly assigned and co-pending patent applications: U.S. patent application Ser. No. 09/378,878 entitled “Methods and Apparatus for Analyzing Operational and Non-operational Data Acquired from Optical Discs” filed Aug. 23, 1999; U.S. Provisional Patent Application Ser. No. 60/150,288 entitled “Methods and Apparatus for Optical Disc Data Acquisition Using Physical Synchronization Markers” filed Aug. 23, 1999; U.S. patent application Ser. No. 09/421,870 entitled “Trackable Optical Discs with Concurrently Readable Analyte Material” filed Oct. 26, 1999; U.S. patent application Ser. No. 09/643,106 entitled “Methods and Apparatus for Optical Disc Data Acquisition Using Physical Synchronization Markers” filed Aug. 21, 2000; U.S. patent application Ser. No. 09/999,274 entitled “Optical Biodiscs with Reflective Layers” filed Nov. 15, 2001; U.S. patent application Ser. No. 09/988,728 entitled “Methods and Apparatus for Detecting and Quantifying Lymphocytes with Optical Biodiscs” filed Nov. 20, 2001; U.S. patent application Ser. No. 09/988,850 entitled “Methods and Apparatus for Blood Typing with Optical Bio-discs” filed Nov. 19, 2001; U.S. patent application Ser. No. 09/989,684 entitled “Apparatus and Methods for Separating Agglutinants and Disperse Particles” filed Nov. 20, 2001; U.S. patent application Ser. No. 09/997,741 entitled “Dual Bead Assays Including Optical Biodiscs and Methods Relating Thereto” filed Nov. 27, 2001; U.S. patent application Ser. No. 09/997,895 entitled “Apparatus and Methods for Separating Components of Particulate Suspension” filed Nov. 30, 2001; U.S. patent application Ser. No. 10/005,313 entitled “Optical Discs for Measuring Analytes” filed Dec. 7, 2001; U.S. patent application Ser. No. 10/006,371 entitled “Methods for Detecting Analytes Using Optical Discs and Optical Disc Readers” filed Dec. 10, 2001; U.S. patent application Ser. No. 10/006,620 entitled “Multiple Data Layer Optical Discs for Detecting Analytes” filed Dec. 10, 2001; U.S. patent application Ser. No. 10/006,619 entitled “Optical Disc Assemblies for Performing Assays” filed Dec. 10, 2001; U.S. patent application Ser. No. 10/020,140 entitled “Detection System For Disk-Based Laboratory and Improved Optical Bio-Disc Including Same” filed Dec. 14, 2001; U.S. patent application Ser. No. 10/035,836 entitled “Surface Assembly for Immobilizing DNA Capture Probes and Bead-Based Assay Including Optical Bio-Discs and Methods Relating Thereto” filed Dec. 21, 2001; U.S. patent application Ser. No. 10/038,297 entitled “Dual Bead Assays Including Covalent Linkages for Improved Specificity and Related Optical Analysis Discs” filed Jan. 4, 2002; U.S. patent application Ser. No. 10/043,688 entitled “Optical Disc Analysis System Including Related Methods for Biological and Medical Imaging” filed Jan. 10, 2002; U.S. Provisional Application Ser. No. 60/348,767 entitled “Optical Disc Analysis System Including Related Signal Processing Methods and Software” filed Jan. 14, 2002 U.S. patent application Ser. No. 10/086,941 entitled “Methods for DNA Conjugation Onto Solid Phase Including Related Optical Biodiscs and Disc Drive Systems” filed Feb. 26, 2002; U.S. patent application Ser. No. 10/087,549 entitled “Methods for Decreasing Non-Specific Binding of Beads in Dual Bead Assays Including Related Optical Biodiscs and Disc Drive Systems” filed Feb. 28, 2002; U.S. patent application Ser. No. 10/099,256 entitled “Dual Bead Assays Using Cleavable Spacers and/or Ligation to Improve Specificity and Sensitivity Including Related Methods and Apparatus” filed Mar. 14, 2002; U.S. patent application Ser. No. 10/099,266 entitled “Use of Restriction Enzymes and Other Chemical Methods to Decrease Non-Specific Binding in Dual Bead Assays and Related Bio-Discs, Methods, and System Apparatus for Detecting Medical Targets” also filed Mar. 14, 2002; U.S. patent application Ser. No. 10/121,281 entitled “Multi-Parameter Assays Including Analysis Discs and Methods Relating Thereto” filed Apr. 11, 2002; U.S. patent application Ser. No. 10/150,575 entitled “Variable Sampling Control for Rendering Pixelization of Analysis Results in a Bio-Disc Assembly and Apparatus Relating Thereto” filed May 16, 2002; U.S. patent application Ser. No. 10/150,702 entitled “Surface Assembly For Immobilizing DNA Capture Probes in Genetic Assays Using Enzymatic Reactions to Generate Signals in Optical Bio-Discs and Methods Relating Thereto” filed May 17, 2002; U.S. patent application Ser. No.10/194,418 entitled “Optical Disc System and Related Detecting and Decoding Methods for Analysis of Microscopic Structures” filed Jul. 12, 2002; U.S. patent application Ser. No. 10/194,396 entitled “Multi-Purpose Optical Analysis Disc for Conducting Assays and Various Reporting Agents for Use Therewith” also filed Jul. 12, 2002; U.S. patent application Ser. No. 10/199,973 entitled “Transmissive Optical Disc Assemblies for Performing Physical Measurements and Methods Relating Thereto” filed Jul. 19, 2002; U.S. patent application Ser. No. 10/201,591 entitled “Optical Analysis Disc and Related Drive Assembly for Performing Interactive Centrifugation” filed Jul. 22, 2002; U.S. patent application Ser. No. 10/205,011 entitled “Method and Apparatus for Bonded Fluidic Circuit for Optical Bio-Disc” filed Jul. 24, 2002; U.S. patent application Ser. No. 10/205,005 entitled “Magnetic Assisted Detection of Magnetic Beads Using Optical Disc Drives” also filed Jul. 24, 2002: U.S. patent application Ser. No. 10/230,959 entitled “Methods for Qualitative and Quantitative Analysis of Cells and Related Optical Bio-Disc Systems” filed Aug. 29, 2002; U.S. patent application Ser. No. 10/233,322 entitled “Capture Layer Assemblies for Cellular Assays Including Related Optical Analysis Discs and Methods” filed Aug. 30, 2002; U.S. patent application Ser. No. 10/236,857 entitled “Nuclear Morphology Based Identification and Quantification of White Blood Cell Types Using Optical Bio-Disc Systems” filed Sep. 6, 2002; U.S. patent application Ser. No. 10/241,512 entitled “Methods for Differential Cell Counts Including Related Apparatus and Software for Performing Same” filed Sep. 11, 2002; U.S. patent application Ser. No. 10/279,677 entitled “Segmented Area Detector for Biodrive and Methods Relating Theret” filed Oct. 24, 2002; U.S. patent application Ser. No. 10/293,214 entitled “Optical Bio-Discs and Fluidic Circuits for Analysis of Cells and Methods Relating Thereto” filed on Nov. 13, 2002; U.S. patent application Ser. No. 10/298,263 entitled “Methods and Apparatus for Blood Typing with Optical Bio-Discs” filed on Nov. 15, 2002; and U.S. patent application Ser. No. 10/307,263 entitled “Magneto-Optical Bio-Discs and Systems Including Related Methods” filed Nov. 27, 2002. All of these applications are herein incorporated by reference in their entireties. They thus provide background and related disclosure as support hereof as if fully repeated herein.

### BRIEF DESCRIPTION OF THE DRAWINGS

These and other features, aspects, and advantages of the present invention will become better understood with regard to the following description, appended claims, and accompanying drawings where:

FIG. 1 is a schematic representation of the development kit and its relationship with hardware components according to one configuration of the present invention;

FIG. 2 depicts the usage of the data visualization software with a BCD analyzer and a computer according to one embodiment of the present invention;

FIG. 3A offers three examples of display including a linear plot, a two-dimensional dimensional graph, and a three-dimensional display;

FIG. 3B is an example three-dimensional graph generated by one embodiment of the present invention;

FIG. 3C is an example data visualization display generated by one embodiment of the present invention;

FIG. 4 is a flow diagram of the process of displaying data from a bio-disc in accordance with one embodiment of the present invention;

FIG. 5A is an example display that has been generated via the process of step interpolation;

FIG. 5B is an example illustrating the process of linear interpolation;

FIG. 6 shows an example bio-disc and its sample area and track configuration;

FIG. 7 is a flow diagram of the process of micro-alignment in accordance with one embodiment of the present invention;

FIG. 8 is a flow diagram of the process of displaying data from an optical bio-disc wherein lines of data shorter than a longest line are padded with a pad value in accordance with the present invention;

FIG. 9 is a flow diagram of the process of displaying data from an optical bio-disc wherein lines of data longer than a shortest line are clipped in accordance with the present invention;

FIG. 10 is a flow diagram of the process of displaying data from an optical bio-disc wherein lines of data are displayed at a selected length in accordance with the present invention;

FIG. 11A is a screen shot showing the displayed data of the present invention; and

FIG. 11B is a screen shot showing the data displayed in a spreadsheet like format according to another aspect of the present invention.

### DETAILED DESCRIPTION OF THE INVENTION

The present invention is a system and method for visualizing data captured via analog hardware means. In the following description, numerous specific details are set forth to provide a more thorough description of embodiments of the invention. It should be apparent, however, to one skilled in the art, that the invention may be practiced without these specific details. In other instances, well known features have not been described in detail so as not to obscure the invention.

Various embodiments of the present invention are directed at visualizing data for the purpose of hardware development, hardware testing, and data analysis. One embodiment of the present invention is a software development kit for analyzing the responses received from any analog-to-digital hardware apparatus. In another embodiment, the data analysis is directed at analyzing and visualizing data received from the reading of a bio-disc containing biological or other samples.

### Development Kit

A/D (analog-to-digital) cards take in analog voltage input and convert it into a digital data output that can be processed by computer software. The present invention provides a complete suite of data visualizing tools for data that is outputted by any A/D card (or equivalent apparatus that outputs such signals). In one embodiment, the software embodiment of the present invention is a development kit suitable for visualizing the data, thus aiding the testing and development process of A/D cards and related software application. In another embodiment, the development kit includes both the software for visualizing the data received and an A/D card for the purpose of capturing analog data. In view of the present disclosure, it would be apparent to one skilled in the art that the present invention can be applied to any device that generates similar signals.

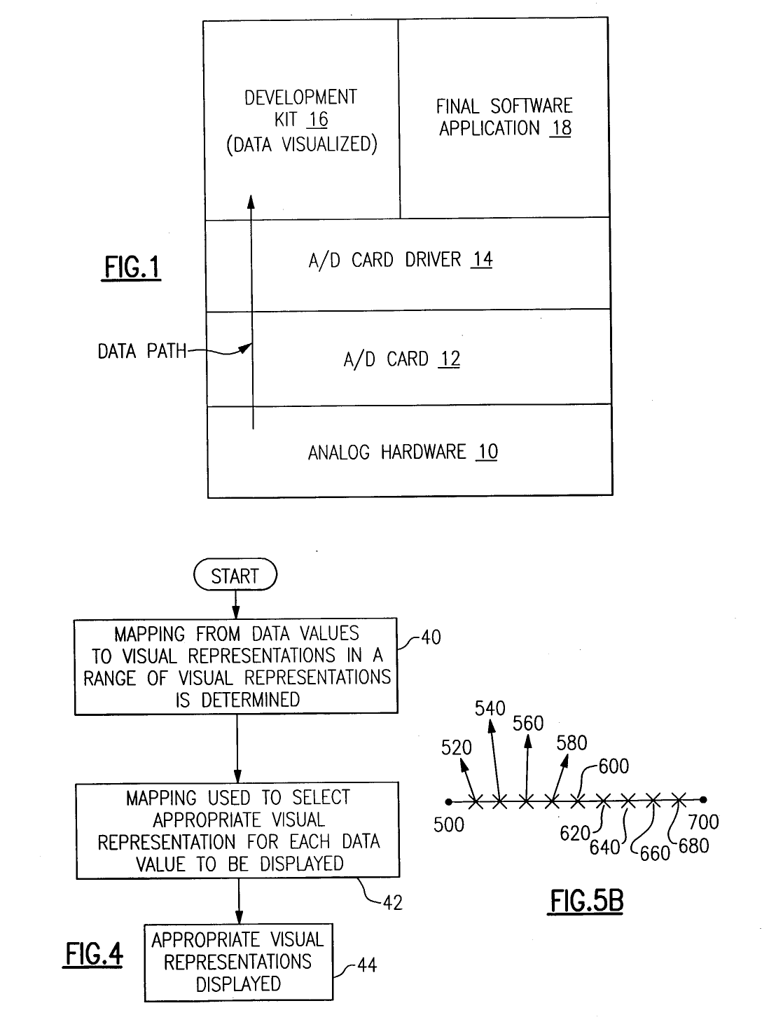

As A/D cards are often coupled with hardware drivers without visualization software, the development kit allows software developers to easily see data output from A/D cards. Thus the development kit aids developers in developing and testing applications using A/D hardware. FIG. 1 shows the abstraction of the relationship between the development kit and the actual analog hardware. Analog signal data is collected at the analog hardware 10. Then the analog signal data is sent to A/D card 12, which converts the analog data to digital output. The data is then sent through the A/D card driver 14 to development kit 16, where the data can be visualized. The developer can run tests with the analog hardware 10 or A/D card 12 through the development kit 16, all the while seeing the data from tests. Finally, with the help development kit 16, the developer can develop final software application 18 that accesses data from analog hardware 10. In another embodiment, the development kit also includes an A/D card and the necessary hardware drivers. This allows the hardware developer to have complete access to the test analog data.

In other usage, hardware developers can use the visualized data displayed on development kit 16 to diagnose problems in analog hardware 10 and/or A/D card 12. In general, both hardware and software developers can use the development kit to test and diagnose any layer in the abstraction presented in FIG. 1.

Other Applications

The development kit of the present invention can be further applied in applications where visualization of data is crucial. As one embodiment of the development kit is comprised of an A/D card apparatus, card controlling driver, and visualization software, the required input to the kit is a standardized output from analog-based hardware. Thus a wide range of application can take advantage of the development kit for the display for data captured via such means. An example of suitable application is terrain mapping. Maps of terrain height plotted against a two-dimensional area can be suitably produced by using the development kit, which converts the data responses into three-dimensional maps. The development kit can also be applied to signals received from sonar sea-floor exploration apparatus, high-power telescopes, speech recognition sensory devices, and other similar or related applications.

Bio-Disc Data Visualization

In another embodiment, the present invention is directed at visualizing data collected from signal responses from optical bio-drives. Co-pending U.S. application titled “Segmented Area Detector for Biodrive and Methods Relating Thereto”, Ser. No. 10/279,677, filed Oct. 24, 2002, describes an example device called BCD (Biological Compact Disc) analyzer that has an analog output which can be used in conjunction with the present invention. The application is fully incorporated by reference.

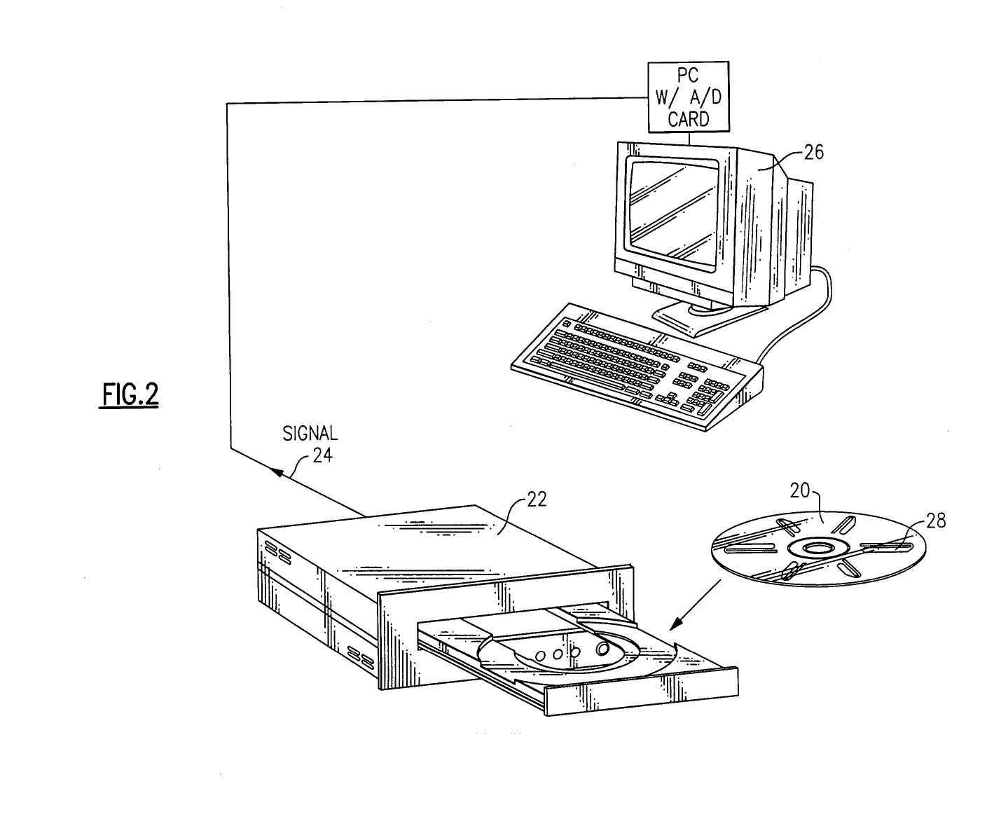

FIG. 2 illustrates such an embodiment. Optical disc 20 includes sample areas 28, where biological samples, for instance, are deposited for the purpose of analysis. In this embodiment, the BCD analyzer 22 reads the inserted optical bio-disc 20 and converts the detected the intensity of light that has interacted with the sample on the bio-disc into voltage signal 24. The signal is then sent to an analog output. The analog output is then directed to a computer system 26 with an A/D card running a software embodiment of the present invention. The user can thus visually manipulate and analyze the received data via the tools included in the present invention. In another embodiment, the optical disc drive component of BCD analyzer 22 resides wholly within computer system 26.

Data Visualization

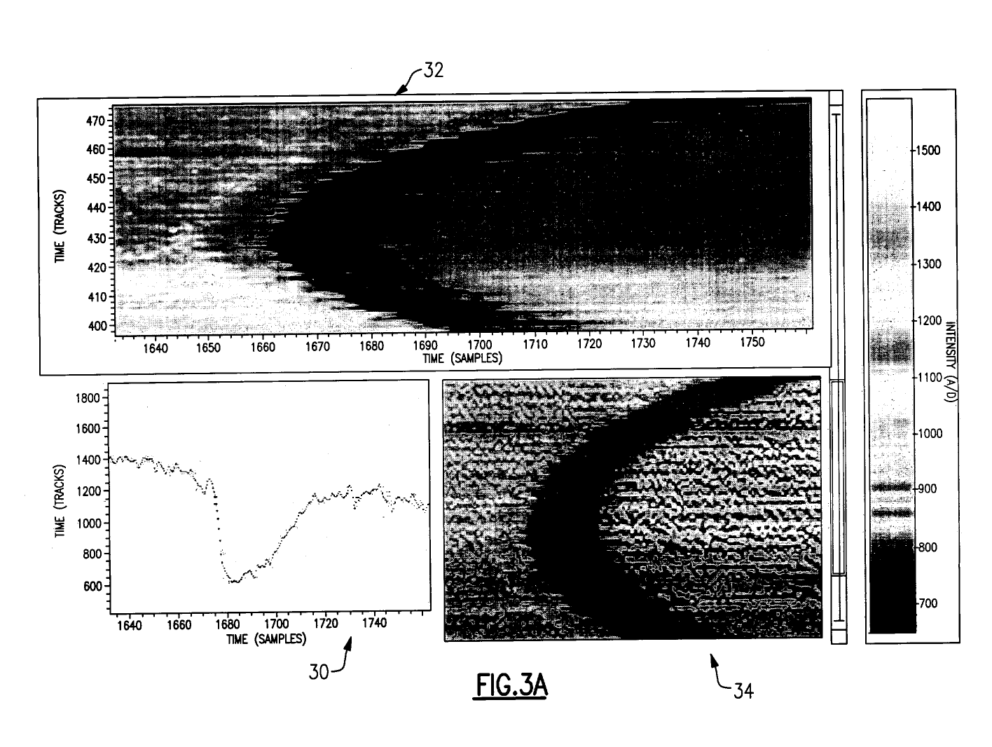

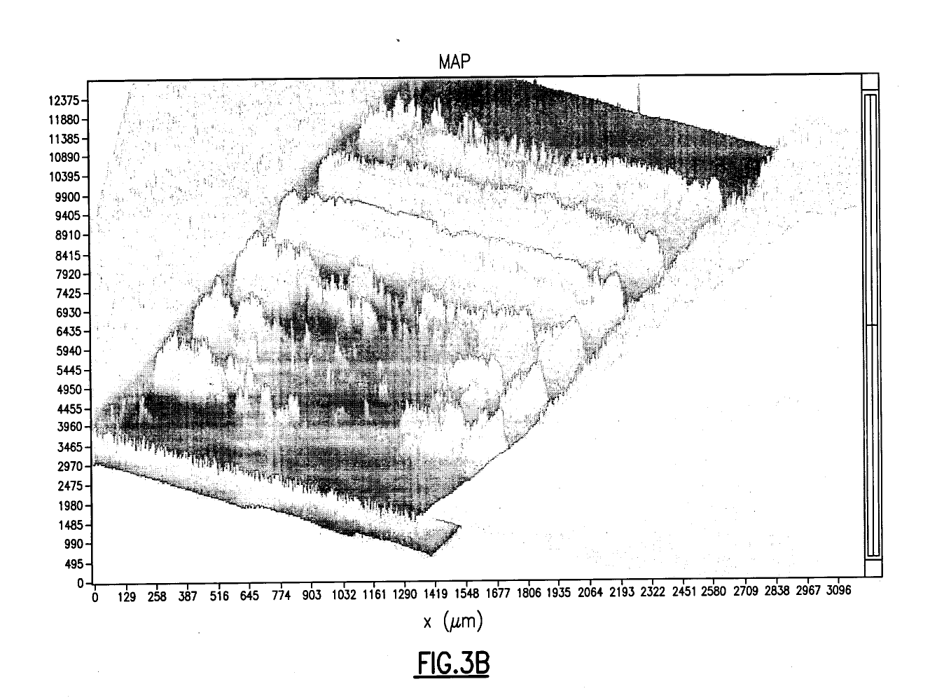

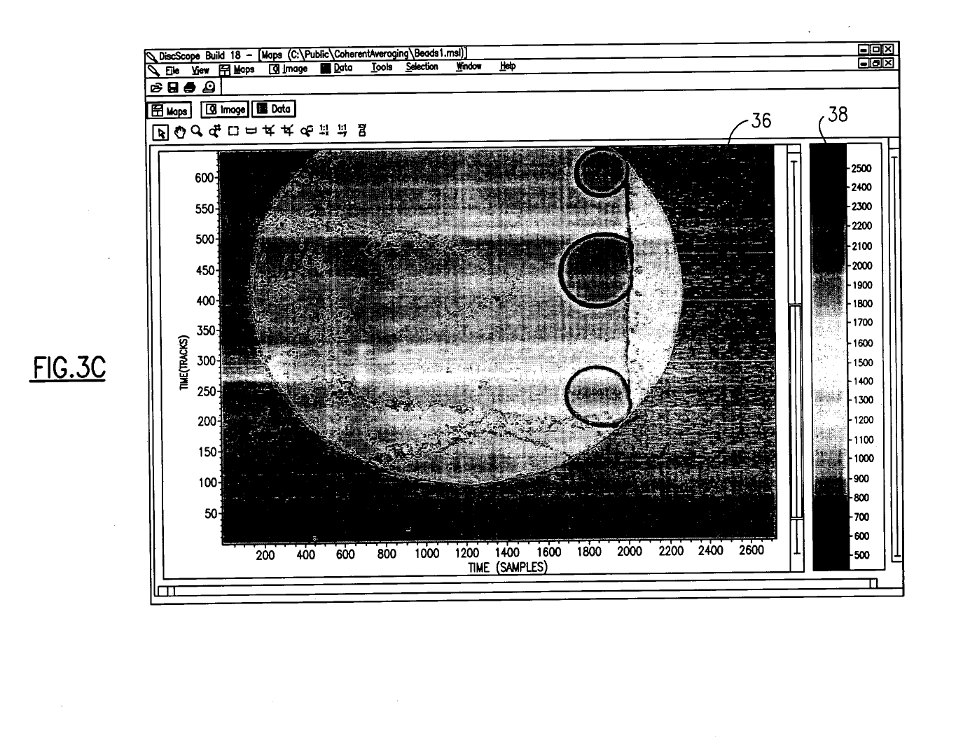

Regardless of the data source (be it bio-disc application or A/D card development kit testing or other analog data capture) the present invention can display data points in a linear fashion, a two-dimensional fashion, or a three-dimensional fashion. An example of each type of display is shown in FIG. 3A. Display 30 is a plot of voltage intensity verses time of an input. Display 32 is a display of voltage intensity with respect to a two-dimensional range. In this example case, the two dimensions are samples and tracks, which are spiral tracks of an optical bio-disc. The two dimensions are not limited to track vs. time on an optical bio-disc and can be applied generally to any application that has such dimensions. Finally, display 34 shows an example of a three-dimensional graph, where third dimension, the height of the intensity, (the Z-axis is coming out of the page) is plotted against the area where the intensity of signal is detected. Another example of a three-dimensional graph is shown in FIG. 3B. In this example, the detected intensity value from an optical bio-disc is now plotted on the Z axis vs. the area of (X axis) sample times vs. tracks (Y axis). Again the dimensions can be applied to any type of analog input and are not restricted to bio-disc usage.

In another embodiment, a fourth dimension, time, can be added to show visualized data. The received data over time is displayed in an animation, which shows a progression of the snapshots of the data display over time. The animation can be displayed in real-time, corresponding to the data received in the analog hardware apparatus. This is particular useful in instances where responses of biological samples to deposited chemical need to be observed. For instance, antibiotic chemical may be deposited into a culture of bacteria in a sample area on an optical bio-disc and the reaction of the bacteria can be observed with the animation offered by this embodiment of the present invention. In another instance, samples can undergo centrifugation as programmed by the spinning of the optical bio-disc by the optical bio-drive. Then the data visualization embodiment of the present invention can create animation of the samples depicting the state of the samples after each iteration of the centrifugation. Other uses of the animation can be applied broadly to observation to any sample that decays or grows over time. Examples of such samples include cell morphology and bacteria growth. Formation of crystals can also be observed via the animation. The animation can also be applied to other uses outside of the field of bio-disc sample observation.

Furthermore, to enable analysis of data, the display can sum, subtract, or otherwise mathematically manipulate data from multiple channels. For example, data from two channels can be summed to create a resultant data display. Another example is the display of one channel of data super-imposed on data from another channel. The visualization of the presentation can handle a plurality of channels of data and can be configured to display any mathematical combination of such data.

User Interface

Besides having the option of viewing the data in a linear, two-dimensional, three-dimensional, and animated fashion, the data visualization component of the present invention includes a user interface with a collection of functions to aid the analysis of visualized data. The user interface of the present invention allows the user to select range of data displayed, zoom in to and out of display windows, change display areas, export/save data, and manipulate the display in a wide variety of manners. Examples of other functions include setting the aspect ratio of the display, changing the color scale mapping of the display, compiling a histogram of the display, and selecting a sub-set range of the input data for display.

The following sections offer further description of the display components of the present invention. They are directed at giving a visual form of converted analog data that is received in an analog hardware apparatus.

Color Mapping

The display of each data item is not limited to a thresholding system with only two visual representations (e.g., black or white). In one embodiment, a range of visual representations is associated with the range of data values. In one embodiment, the range of representations is gray scale. In another embodiment, the range of representations is in colors (color scale). In one embodiment, the user determines the range of representations and how data values are mapped into the range. FIG. 3C shows a display 36 with a corresponding color range 38.

FIG. 4 illustrates the process of displaying data from a bio-disc in accordance with one embodiment of the present invention. At block 40, a mapping from data values to visual representations in a range of visual representations is determined. In one embodiment, the mapping is a smooth, linear mapping. In another embodiment, the mapping is not a smooth mapping (e.g., 90% of the possible data values map to 5% of the available representations in the range and the other possible data values map to the other 95% of the available representation). In one embodiment, the user selects from a collection of pre-defined mappings. In another embodiment, the user may modify a pre-defined mapping. In yet another embodiment, the user generates an original mapping. At block 42, the chosen mapping is used to select appropriate visual representation for each data value to be displayed. Finally, at block 44, the appropriate visual representation is displayed.

Interpolation

The present invention allows user to manipulate the display of the visualized data. User can zoom in/out and scroll to various parts of the visualized data. Because of this, sometimes, at block 42, interpolation is used to select a visual representation for one or more data values. This is needed in the case where the user has “over-zoomed” on-screen, creating the scenario where there are more pixels showing that there are data points. Interpolation is used to assign values to pixels that do not have directly-mapped (corresponding) data values. Methods of interpolation are used include the step method, the linear method and the quadratic method.

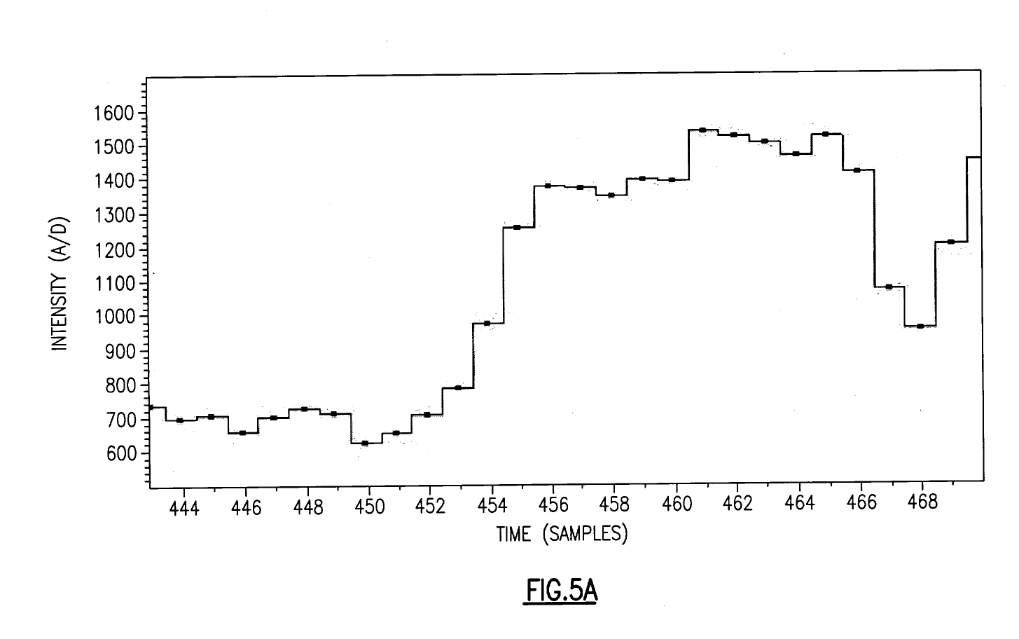

The step interpolation method assigns values of adjacent pixels to a pixel that has a directly-mapped data value. The end effect is the appearance of small steps in the data display, as demonstrated in the linear plot of FIG. 5A. The step interpolation method can also be applied to two-dimensional and three-dimensional displays. In a two-dimensional display, for instance, all pixels in a square of 5×5 pixels may have the value of the pixel in the center point of the square, where the center point is an actual data point value. The same idea can be extended to three-dimensional display where a collection of points in a rectangular column can take on the value of the center point of the column. Any other appropriate three-dimensional shape can be used in accordance to the step interpolation of the three-dimensional display.

Another interpolation method is called linear interpolation. In this method, pixels that are between pixels with directly-mapped data value receive values based on a linear interpolation between the directly-mapped data value pixels. An example is shown in FIG. 5B. For instance, between two pixel points of values 500 and 700, all pixels that lie on a line between those two points receive a gradation value between 500 and 700 based on the linear equation that describes that line. This principle is applied to both two and three-dimensional displays.

Another interpolation method is a type of quadratic interpolation. Briefly, the basic conceptual idea behind the method is to take four pixels as control points and create a function that runs through the four pixels and thus creating extra pixels along the line described by the function. The four pixels can be thought of the available data points in the case of the present invention and the additional pixels to be generated are the interpolated ones.

More specifically, this method takes one in a collection of cubic polynomials used in interpolating a function. The value of the function is specified at each of a collection of distinct ordered values X_{I}, where I is 1, . . . , N. The function has a slope that is specified at X₁ and X_{N}. One cubic polynomial is found for each interval such that that the interpolating system has the prescribed values at each of the X₁, the prescribed slope at X₁ and X_{N} and a continuous slope at each of the X_{I}. Thus a function can be traced out of discrete points. This idea can be extracted to interpolate pixel values between data points in all forms of display supported in the present invention.

Alignment of Data

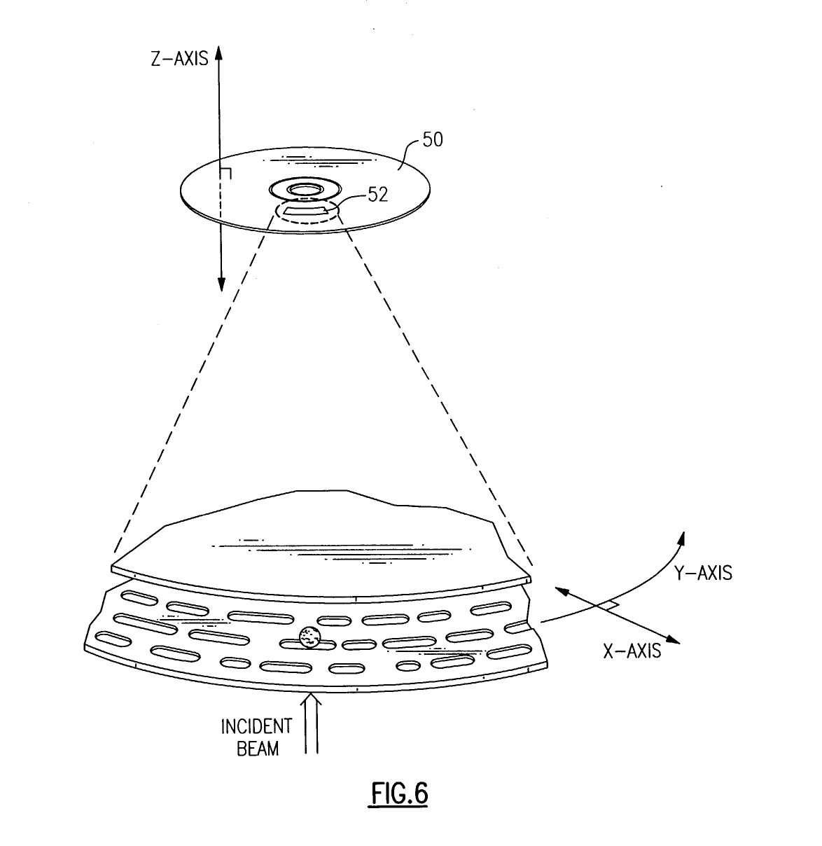

In one embodiment of the present invention, the visualized data is generated from signal corresponding to sample areas of an optical bio-disc. Since signals are recorded along the spiral tracks of the optical bio-disc, the outer tracks of a sample area are longer than the inner tracks of the same area. The example disc 50 with sample area 52 in FIG. 6 illustrates this property. Therefore if data from each track is lined up without alignment, distortion may result.

Alignment is needed to present a smooth visualization of data. In one embodiment, the data from the tracks comprising a display are left-justified. In another embodiment, the data from the tracks comprising a display are centered. In another embodiment, the data from the tracks comprising a display are right-justified.

In yet another embodiment, micro-alignment is used in displaying the data. The position of each line of data is shifted within a known, small range to determine the best fit relative to other data. Thus, small variances caused by imperfections such as disc wobble are corrected.

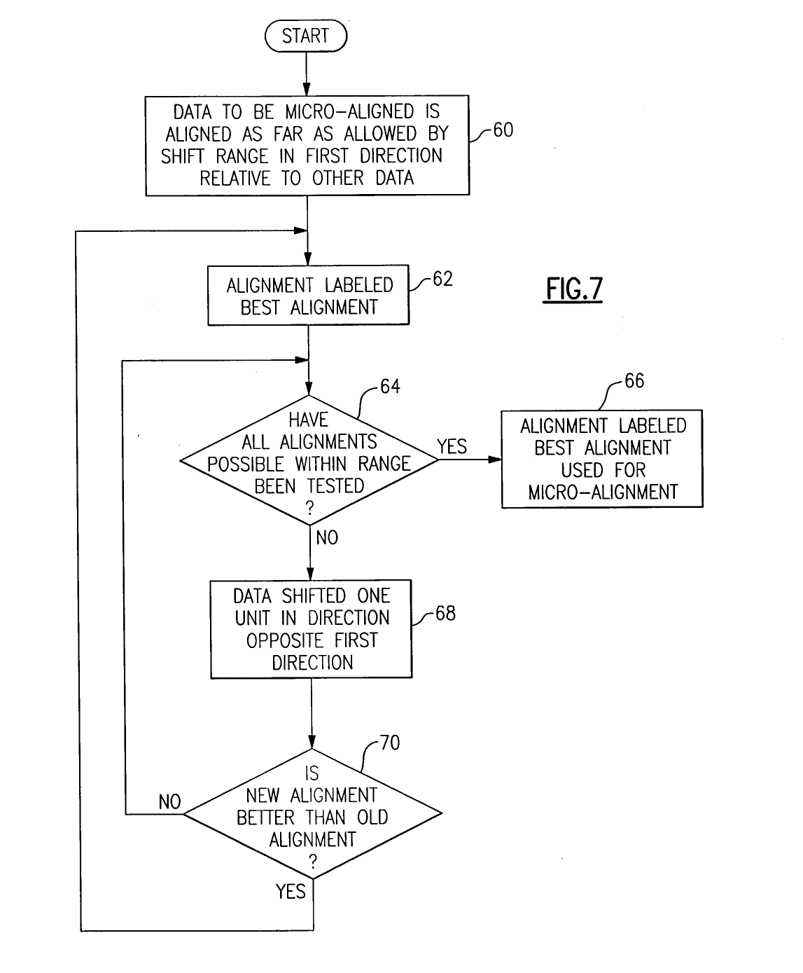

FIG. 7 illustrates the process of micro-alignment in accordance with one embodiment of the present invention. At block 60, the data to be micro-aligned is aligned as far as is allowed by the shift range in a first direction relative to the other data. For example, a row of data might be moved as far to the left as possible relative to the row (or rows) before it. At block 62, the alignment is labeled the best alignment. At block 64, it is determined whether all alignments possible within the range have been tested. If all alignments possible within the range have been tested, at block 66, the alignment labeled as the best alignment is used for the micro-alignment. If not all alignments possible within the range have been tested, at block 68, the data is shifted one unit in a direction opposite of the first direction. In our example, the row of data might be shifted right, one unit at a time until block 66 determines there is no more new alignment to test.

At block 70, it is determined whether the new alignment is better than the old alignment. If the new alignment is better than the old alignment, the process repeats at block 64. If the new alignment is not better than the old alignment, the process repeats at block 66. The basic idea of the loop formed by 64, 66, 68, and 70 is that the method tries all possible alignments and finds the best one by shifting the data one unit at a time.

In one embodiment, at block 70, the system thresholds the data in one line to categorize it into two groups (e.g., 1's and 0's) and then performs an exclusive or (XOR) with other data to determine the best fit to align the line of data with the other data. A lower number of 1's resulting from the XOR indicates better alignment. In another embodiment, no thresholding is performed, and instead the gradient is measured. The alignment with the smoothest gradient is the desired alignment.

In another embodiment, the determination at block 70 is accomplished by subtracting the values of corresponding data points. For example, given the following two example tracks (shown with the data point values):

| | | | | | | | | | | |
|---|---|---|---|---|---|---|---|---|---|---|
| Track A | 23 | 34 | 45 | 56 | 55 | 55 | 56 | 66 | 70 | 90 |
| Track B | 34 | 44 | 45 | 45 | 56 | 55 | 66 | 65 | 78 | 89 |
| Difference - (Average: | 11 | 10 | 0 | 11 | 1 | 0 | 10 | 1 | 8 | 1 |
| 5.3) | | | | | | | | | | |

Track A is moved one unit at a time to the right, for example, with respect to the adjacent track B. Each movement is followed by a calculation similar to the one shown above, where the differences between data point values of corresponding positions are calculated. An average of the differences is calculated. Finally the alignment with the lower average difference is selected as the best alignment. In another embodiment, instead of taking the difference of the two corresponding data values, the two corresponding data values are multiplied. An average of all the products is calculated and the alignment position that generates the highest average of products is used as the best alignment. The product calculation takes advantage of the faster speed of the multiply operation in the hardware.

In some embodiments, the unit length of the range for the micro alignment is less than a millimeter. In another embodiment, the range is less than 50 microns. Thus the alignment adjustment often is very precise, matching the need to align data from received from minute samples on an optical bio-disc. In various embodiments, micro-alignment is used in conjunction with left-justification, right-justification, or centering to improve the appearance of the alignment.

Uniform Length of Display Lines—Padding

In one embodiment, lines of data are clipped and/or padded to make all tracks (display lines) of uniform length. In one embodiment, a user specifies that all lines should be displayed as being the same length as the longest line. Shorter lines are padded with a pad value (e.g., 0, 1, or another predetermined number) to make them the same length as the longest line. In one embodiment, the padding is done after the lines are aligned. Thus, if center or micro alignment is used, pad values will be added to both the beginning and end of short data lines. Similarly, if right or left justification is used, pad values will be added to the beginning or end, respectively, of shorter lines.

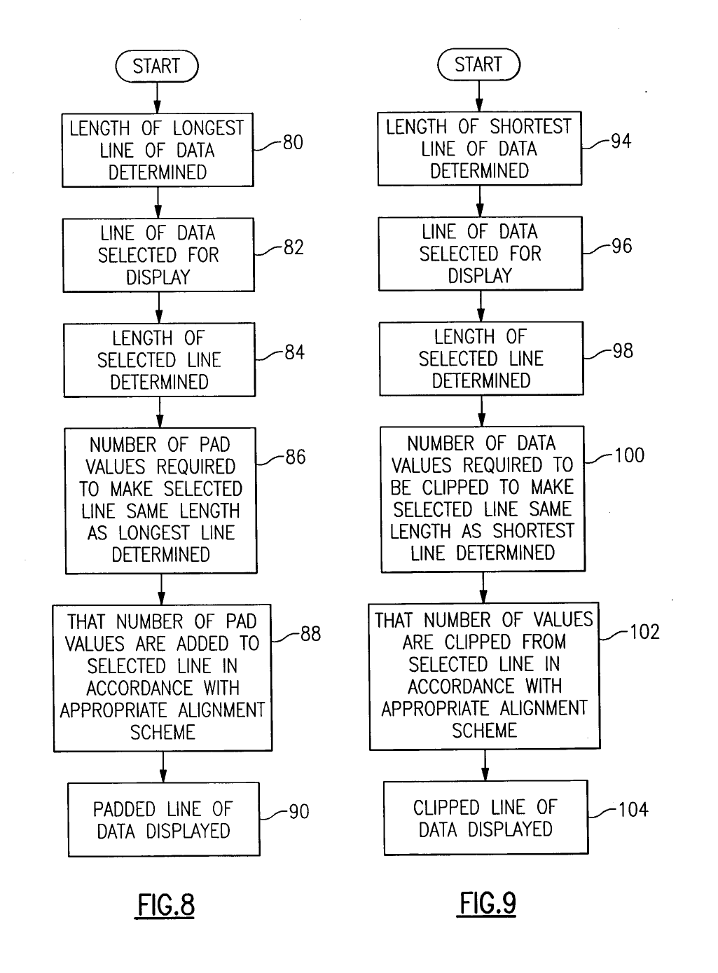

FIG. 8 illustrates the process of displaying data from an optical bio-disc wherein lines of data shorter than a longest line are padded with a pad value in accordance with the present invention. At block 80, the length of the longest line of data is determined. At block 82, a line of data is selected for display. At block 84, the length of the selected line is determined. At block 86, a number of pad values required to make the selected line the same length as the longest line is determined. At block 88, that number of pad values are added to the selected line in accordance with the appropriate alignment scheme. At block 90, the padded line of data is displayed.

Uniform Length of Display Lines—Clipping

In another embodiment, a user specifies that all lines should be displayed as being the same length as the shortest line. Longer lines are clipped to make them the same length as the shortest line. In one embodiment, the clipping is done after the lines are aligned. Thus, if center or micro alignment is used, data values will be clipped from both the beginning and end of long data lines. Similarly, if right or left justification is used, the beginning or end, respectively, of longer lines will be clipped.

FIG. 9 illustrates the process of displaying data from an optical bio-disc wherein lines of data longer than a shortest line are clipped in accordance with the present invention. At block 94, the length of the shortest line of data is determined. At block 96, a line of data is selected for display. At block 98, the length of the selected line is determined. At block 100, a number of data values required to be clipped to make the selected line the same length as the shortest line is determined. At block 102, that number of values are clipped from the selected line in accordance with the appropriate alignment scheme. At block 104, the clipped line of data is displayed.

Uniform Length of Display Lines—Matching a Desired Length

In yet another embodiment, a user specifies that all lines should be displayed as being some desired length. Longer lines are cut and shorter lines are padded with a pad value (e.g., 0, 1, or another predetermined number) to make them the desired length. In one embodiment, the padding and/or clipping is done after the lines are aligned.

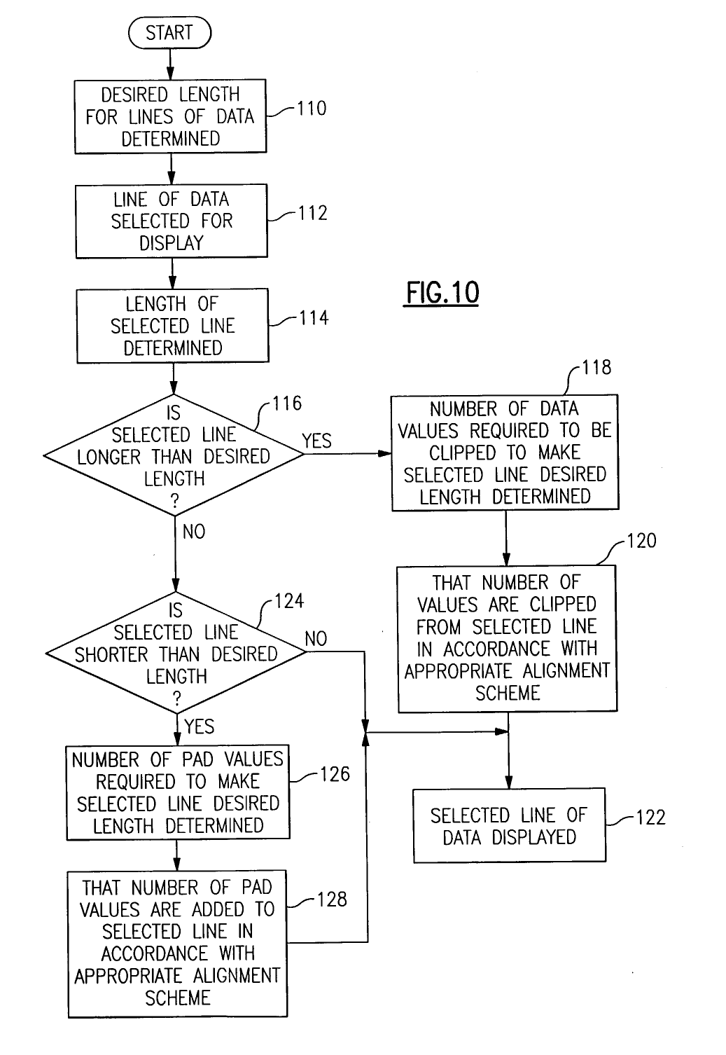

FIG. 10 illustrates the process of displaying data from an optical bio-disc wherein lines of data are displayed at a selected length in accordance with the present invention. At block 110, a desired length for the lines of data is determined. At block 112, a line of data is selected for display. At block 114, the length of the selected line is determined. At block 116, it is determined whether the selected line is longer than the desired length. If the selected line is longer than the desired length, at block 118, a number of data values required to be clipped to make the selected line the desired length is determined. At block 120, that number of values are clipped from the selected line in accordance with the appropriate alignment scheme. At block 122, the selected line of data is displayed.

If the selected line is not longer than the desired length, at block 124, it is determined whether the selected line is shorter than the desired length. If the selected line is not shorter than the desired length, the process continues at block 122. If the selected line is shorter than the desired length, at block 126, a number of pad values required to make the selected line the desired length is determined. At block 128, that number of pad values are added to the selected line in accordance with the appropriate alignment scheme and the process continues at block 122.

Display of Data

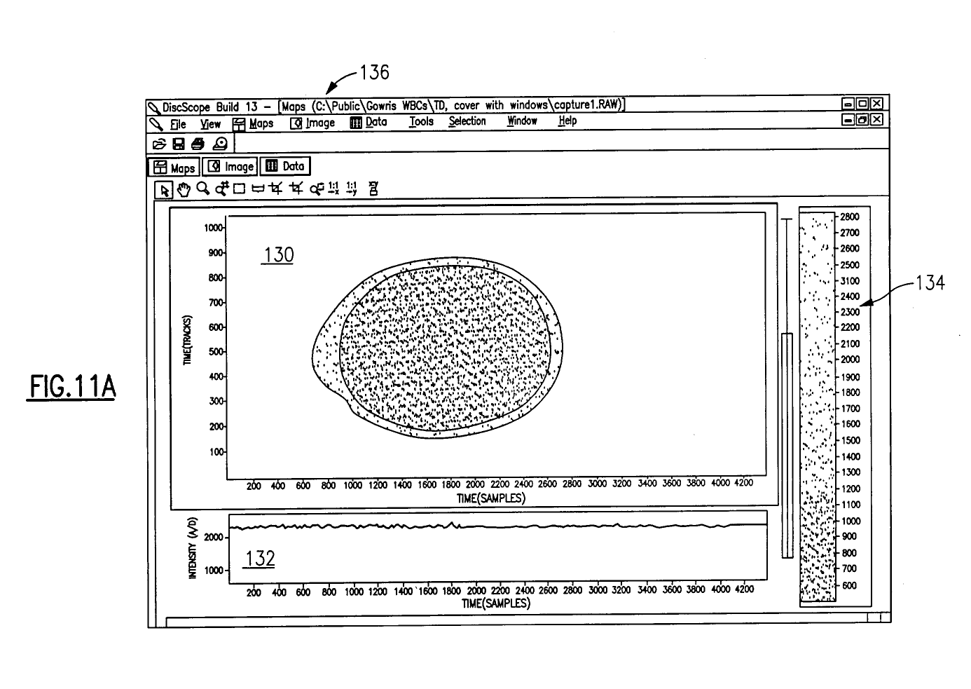

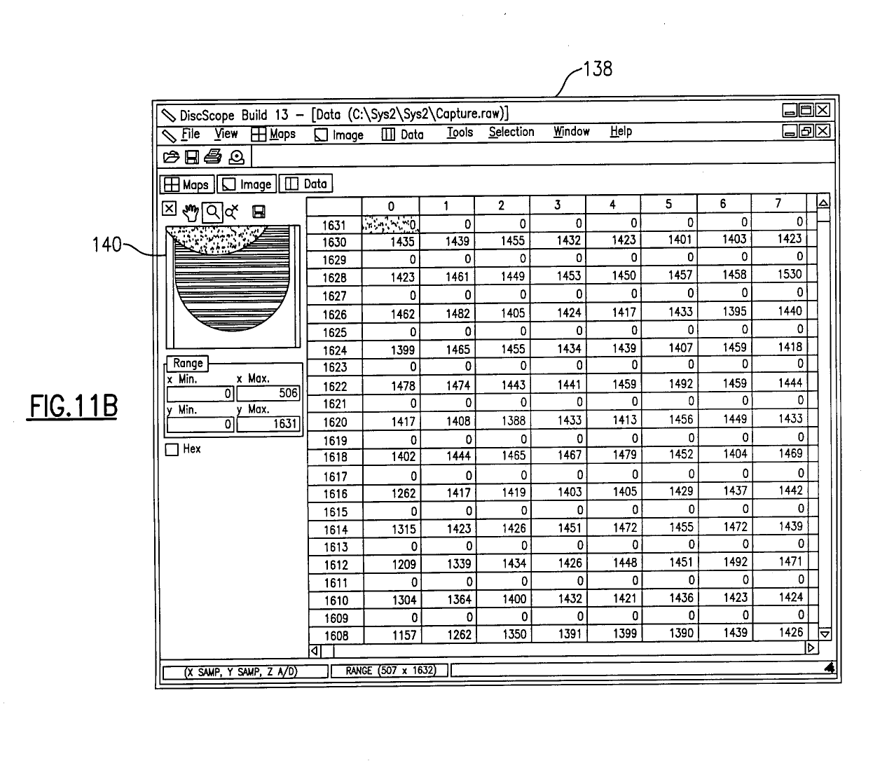

FIG. 11A is a screen shot that shows an example display of data according to an embodiment of the present invention. There is main screen 130 showing an example cell from a sample area of a bio-disc, a voltage trace 132 and an color intensity scale 134. User can select where the voltage trace 132 corresponds to in main screen 130 in by selecting the area that is to be traced out in main screen 130. The color intensity scale 134 shows the how the range of displayed color in the main screen 130 corresponds to the range of input data. This gives the user a guide to interpret the color display in main screen 130.

Numerous functions (e.g. alignment, zoom, display in color scale, etc.) of the present invention can be accessed via the menu 136. FIG. 11B shows the values of the data points of the detected area in a track vs. sample time spreadsheet-like display 138, along with a thumb-nail representation of the visualized data in window 140.

Export and Saving of Data

In one embodiment of the present invention, a data file can be saved as a raw file. Furthermore, a data file can be exported as an image file (e.g. Tiff, BMP, etc) or a CSV (Comma Separated Values) file. In one embodiment, data can further be saved as a Minimum Sample File (MSF).

Concluding Statements

It is to be understood that the above-described techniques of data alignment, padding, clipping, length matching, and data storage are not limited to the bio-disc analysis application. Other applications in which data can be distorted can be compensated by the visualization improvement techniques described in the present invention.

Thus, methods and apparatus for visualizing data from an analog source is described in conjunction with one or more specific embodiments. And while this invention has been described in detail with reference to certain preferred embodiment), it should be appreciated that the present invention is not limited to those precise embodiments. Rather, in view of the present disclosure which describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

We claim:

1. A development kit, comprising:
an A/D card;
a software driver for controlling said A/D card; and
a data visualization software for displaying data retrieved from said A/D card, whereby diagnostic tests can be conducted on a computer running said data visualization software.

2. The development kit of claim 1 wherein said data visualization software displays data in a linear fashion.

3. The development kit of claim 1 wherein said data visualization software maps said retrieved data to a color scale.

4. The development kit of claim 3 wherein said data visualization software displays data in a two-dimensional fashion.

5. The development kit of claim 3 wherein said data visualization software displays data in a three-dimensional fashion.

6. The development kit of claim 1 wherein said data visualization software maps said retrieved data to a gray scale.

7. The development kit of claim 6 wherein said data visualization software displays said retrieved data in a two-dimensional fashion.

8. The development kit of claim 6 wherein said data visualization software displays said retrieved data in a three-dimensional fashion.

9. The development kit of claim 1 wherein said data visualization software displays said retrieved data from multiple channels.

10. The development kit of claim 1 wherein said data visualization software manipulates data from multiple channels and displays the resultant data.

11. The development kit of claim 1 wherein said data visualization software displays animation of data changing with respect to time.

12. The development kit of claim 1 wherein said data visualization software further includes a user interface for interacting with said data.

13. The development kit of claim 12 wherein said user interface further comprises a zoom function, a scroll function, and a color scale mapping.

14. A bio-disc data display system, comprising:
a interface for receiving analog data from a bio-disc reading apparatus;
a A/D card for converting said analog data to digital data; and
an alignment unit configured to align said data using an alignment scheme.

15. The bio-disc data display system of claim 14 wherein said alignment scheme is left-justification.

16. The bio-disc data display system of claim 14 wherein said alignment scheme is right-justification.

17. The bio-disc data display system of claim 14 wherein said alignment scheme is centering.

18. The bio-disc data display system of claim 14 wherein said alignment scheme is micro-alignment.

19. The bio-disc data display system of claim 14 further comprising a selection unit configured to select a representation value for a data item from a range of representation values, said range having at least three representation values such that said data item is part of said data from said optical bio-disc.

20. The bio-disc data display system of claim 19 wherein said range is a gray scale.

21. The bio-disc data display system of claim 19 wherein said range is a color scale.

22. The bio-disc data display system of claim 19 wherein said selection unit comprises:
a mapping generation unit configured to generate a mapping from a range of possible data values to said range of representation values; and
a determiner configured to determine said representation value from said data item using said mapping.

23. The bio-disc data display system of claim 19 wherein said selection unit comprises an interpolation unit configured to interpolate between at least two representation values to produce said representation value.

24. The bio-disc data display system of claim 14 further comprising a line sizing unit configured to make a line of said data a desired length.

25. The bio-disc data display system of claim 24 wherein said line sizing unit comprises a padding unit configured to pad said line of said data with a pad value if a length of said line is less than said desired length.

26. The bio-disc data display system of claim 24 wherein said padding unit comprises an appending unit configured to append said pad value to the end of said line.

27. The bio-disc data display system of claim 24 wherein said padding unit comprises an appending unit configured to append said pad value to the beginning of said line.

28. The bio-disc data display system of claim 24 wherein said line sizing unit comprises a cutting unit configured to remove a data item from said line of said data if a length of said line is greater than said desired length.

29. The bio-disc data display system of claim 24 wherein said cutting unit removes said data item from the end of said line.

30. The bio-disc data display system of claim 24 wherein said cutting unit removes said data item from the beginning of said line.

31. The bio-disc data display system of claim 14 further comprising a data export unit for saving data into a computer file.

32. The bio-disc data display system of claim 14 further comprising a user interface.

33. The bio-disc data display system of claim 32 wherein said user interface further comprises a zoom function, a scroll function, and a color scale mapping.

34. The bio-disc data display system of claim 32 wherein said user interface further comprises a main screen for display said data, a color scale, and a trace scale mapping.

35. The bio-disc data display system of claim 32 wherein said user interface further comprises:
a spread-sheet data point display for said data;
a range selector; and
a thumb nail visualization of said data.

36. A method of displaying data from an optical bio-disc, said method comprising the steps of:
receiving tracks of data from a bio-disc reading apparatus;
assembling said tracks of data into arrays of data that resemble the configuration of sample areas of bio-disc; and
displaying said assembled data.

37. The method of claim 36 further comprises the step of aligning said tracks of data using left-justification.

38. The method of claim 36 further comprises the step of aligning said tracks of data using right-justification.

39. The method of claim 36 further comprises the step of aligning said tracks of data using centering.

40. The method of claim 36 further comprises the step of aligning said tracks of data using micro-alignment.

41. The method of claim 36 wherein said step aligning using micro-alignment further comprises:
moving a first track one unit a time with respect to a second track that is adjacent to said first track;
comparing the data values of corresponding units in said first track and said second track; and
repeating said steps of moving and comparing until a best alignment is found.

42. The method of claim 41 wherein said step of comparing uses a method of taking XOR of corresponding data values in said first and second tracks.

43. The method of claim 42 wherein said best alignment is the position producing the least amount of 1′s using said XOR comparison.

44. The method of claim 41 wherein said step of comparing uses a method of taking the average of the differences between data values in corresponding units from said first track and said second track.

45. The method of claim 44 wherein said best alignment is the position producing the lowest average of the differences.

46. The method of claim 41 wherein said step of comparing uses a method of taking the average of the products of data values in corresponding units from said first track and said second track.

47. The method of claim 46 wherein said best alignment is the position producing the highest average of the products.

48. The method of claim 36 further comprising the step of selecting a representation value for a data item from a range of representation values, said range having at least three representation values so that said data item is part of said data from said optical bio-disc.

49. The method of claim 47 wherein said range is a gray scale.

50. The method of claim 47 wherein said range is a color scale.

51. The method of claim 48 wherein said step of selecting comprises the steps of:
generating a mapping from a range of possible data values to said range of representation values; and
determining said representation value from said data item using said mapping.

52. The method of claim 48 wherein said step of selecting comprises interpolating between at least two representation values to produce said representation value.

53. The method of claim 52 wherein said step of interpolating uses step interpolation.

54. The method of claim 52 wherein said step of interpolating uses linear interpolation.

55. The method of claim 52 wherein said step of interpolating uses cubic spline interpolation.

56. The method of claim 36 further comprising making a track of said data a desired length.

57. The method of claim 56 wherein said step of making comprises padding said track of said data with a pad value if a length of said track is less than said desired length.

58. The method of claim 57 wherein said step of padding comprises appending said pad value to the end of said track.

59. The method of claim 57 wherein said step of padding comprises appending said pad value to the beginning of said track.

60. The method of claim 56 wherein said step of making comprises removing a data item from said track of said data if a length of said track is greater than said desired length.

61. The method of claim 60 wherein said step of removing comprises removing said data item from the end of said track.

62. The method of claim 60 wherein said step of removing comprises removing said data item from the beginning of said track.

63. A method of visualizing analog data, said method comprising the steps of:
connecting an analog data source to an A/D card;
converting said analog data source to a digital data source with said A/D card; and
using a data visualization software to visualize said digital data source.

64. A method of conducting a biological assay, said method comprising the steps of;
depositing a sample onto a sample area of an optical bio-disc;
reading said optical bio-disc with an optical bio-disc analyzer;
receiving a signal from said optical bio-disc analyzer; and
converting said data signal into an animation using a visualization software whereby changes of said sample over time can be observed.

65. The method of claim 64 further comprising the steps of:
depositing a chemical into said sample area of said optical bio-disc; and
observing the responses of said sample to said chemical in said animation.

66. The method of claim 64 further comprising the steps of:
centrifuging said optical bio-disc a plurality of times; and
observing the responses of said sample after each centrifugation in said animation.

67. A method of testing an A/D card comprising:
performing tests on an A/D card;
receiving digital data converted by an A/D card; and
running a data visualization software for displaying said data from said test runs.

68. The method of claim 67 wherein said visualization software displays said data in a linear fashion.

69. The method of claim 67 wherein said visualization software displays said data in a two-dimensional fashion.

70. The method of claim 67 wherein said visualization software displays said data in a three-dimensional fashion.

71. The method of claim 67 wherein said visualization software displays said data in an animated fashion.
